(19) United States
(12) Patent Application Publication
(10) Pub. No.: US 2012/0095589 A1
(43) Pub. Date: Apr. 19, 2012

(54) SYSTEM AND METHOD FOR 3D SHAPE MEASUREMENTS AND FOR VIRTUAL FITTING ROOM INTERNET SERVICE

(76) Inventor: Arkady Vapnik, Santa Monica, CA (US)

(21) Appl. No.: 13/274,541

(22) Filed: Oct. 17, 2011

Related U.S. Application Data
(60) Provisional application No. 61/393,434, filed on Oct. 15, 2010.

(51) Int. Cl. G06F 19/00

(52) U.S. Cl. 700/132

(57) ABSTRACT

A method of detecting the 3D shape of human body and a system of providing Virtual Fitting Room (VFR) service to online retailers over the Internet, in which customer films her/his body moving in front of the camera in a body suit with visible markers. Film is uploaded to the VFR system and processed there by extracting markers coordinates, by tracking markers from frame to frame to achieve automatic registration, and by performing photogrammetric processing of the marker coordinates to obtain and store 3D shape of the customer body. Customer selects an apparel item on an online retailer website, online retailer computer sends a request for fitting service to the VFR system, VFR system retrieves and processes customer digitized 3D body shape and digitized representation of the apparel item, returns virtual images of the customer fitted in the item to online retailer for display of the images to customer.

### CROSS-REFERENCE TO RELATED APPLICATION

This application claims priority to the provisional application U.S. 61/393,434 filed on Oct. 15, 2010.

### FIELD OF THE INVENTION

The invention relates to measuring a three-dimensional shape of any object including human body and virtual fitting of a digitized clothing on a digitized body shape.

### BACKGROUND

Internet shopping has attain critical mass and represents significant and growing portion of the overall retail sales. In the area of clothing, on-line shopping, suffers from inability of current software shopping platforms to let customer see on-line, how the particular garment piece fits them.

There are several approaches to creating virtual fitting room on the Internet. The most advanced approach is an attempt to match customer body parameters with one of several predefined avatars and show the customer picture of the avatar virtually fitted in the selected clothing item. This approach is inaccurate and cumbersome for the consumer since it requires consumer to take many manual measurements of her body.

Second approach is to superimpose 2D image of the clothing item on the 2D picture of the consumer. This approach is more about style and does not provide any idea about fit of the clothing item. (U.S. Patent application Pub. No. 20100034457, U.S. Patent application Pub. No. 20110040539, U.S. Pat. No. 7,714,912)

Third approach, gaining popularity now, is a “social shopping”. Online retailers are implementing technology to enable and encourage users to share their selection of clothing with friends, give and receive advice. They often center their website around pictures of celebrities, show large number of pictures taken from different angles and with different combinations of other clothing items to showcase what they have for sale.

The apparel design houses utilize CAD software, thus most of the garment items available for sale have digital representation of the patterns used in their construction.

Some of the garment CAD design packages, for example, Tukatech, have software combining patterns, generated by the pattern makers, in the complete garment item and virtually sewing this garment on the model's digitized 3D shape to check the look and the fit of the apparel item before making a sample. This software has an ability to show apparel designers parts of the clothing item fitting excessively tight by employing color coded scheme of the generated image.

Apparel virtual prototyping software did not make significant inroads in the apparel retail for one reason—there is no simple, inexpensive and reliable technology to precisely measure 3D customer body dimensions. Various methods of body feature recognition software, image depth maps and encoded markers to enable automatic registration of the markers used by photogrammetry software, special scanning booths at retailer location, proved to be expensive, inconvenient or very complex and unreliable for retail applications.

U.S. Pat. Nos. 7,489,813 and 7,298,889 (and other patents of the same inventor) describe method of photogrammetric detection of 3D body shape of the object using enveloping body suit with encoded markers. This method relies on complex encoding of the markers to achieve automatic marker registration needed for photogrammetry software and thus requires high-resolution cameras and trained personal.

There is no software system implementing Virtual Fitting Room internet based service for internet apparel retailers, the system, which combines ability to acquire and store digitized 3D body shapes of the customers; processes on-line apparel retailers requests to fit selected apparel item over a customer's virtual body; modeling software to fit digitized representation of the garment item over the digitized 3D shape of the customer body; create a realistic fit and image of the customer, wearing this garment.

Existing implementations of Virtual Fitting Room (VFR) are centered around individual retailer. They require customer to enter body parameters on the website of the retailer and limit customer options to this retailer merchandize. Retailers use different schemes of describing customer body, different methods of entering apparel item parameters, making comparison shopping impossible. As a result none of the existing VFR platforms gained wide acceptance. There is a need for unified fitting room, which allows dressing customers in various apparel items of different producers.

### SUMMARY OF THE INVENTION

In this submission, a new method and system for obtaining 3D shape of the object including 3D human body shape measurements is described. The proposed invention is not limited to the human body or parts of the human body measurements, and should be considered as a general approach to determine a 3D shape of an object.

The measurement is based on a technique that uses motion film instead of still pictures. The technique utilizes tracking of the markers placed on the body to achieve auto registration of the markers necessary for the proper functioning of the photogrammetry software. It does not require scanning booth, expensive camera equipment, special types of marking the body, installation of complex software packages on the customer computer, special lighting requirements, and training.

Body measurements utilizing this technology, could be carried in a privacy of consumer home and transmitted over the Internet. In one embodiment, the image is acquired using any networked notebook computer with a build-in or attached web camera.

In addition, this submission describes software system consisting of two components: client/server component to measure consumer 3D body shape; virtual fitting room (VFR) software component residing on the VFR server and implementing various functions needed for VFR deployment as an internet based service for the online apparel retailers.

Client software resides on the consumer computer; supports voice/sound interface or other standard means of computer interface, to operate the camera; it collects the motion film of the consumer, and relays it to the VFR server.

Server side of the client/server component receives and processes motion film to generate and store consumer 3D body dimensions.

Consumer selects garment items on the retailer website for fitting. This request is forwarded by the retailer website to the VFR server.

VFR server retrieves customer body dimensions from its database, requests and receives digitized representation of the selected garment item from the digitized garments database; generates images of the garment item fitted on the consumer body, sends these images to the retailer website for displaying to the consumer. If consumer likes the images and decides to buy selected item, she can proceed to the retailer check-out.

### BRIEF DESCRIPTION OF DRAWINGS

FIG. 1 is a picture of the enveloping body suit with markers, fitted on the human body;

FIG. 2 is a picture showing setup for filming motion picture of customer body;

FIG. 3 is a picture showing setup for taking tape measurement of the waist length, used as the reference for scaling 3D body shape to actual physical dimensions;

FIG. 4 is a picture of the costume segment from two sequential frames illustrating tracking of the markers across sequential frames for automatic registration;

FIG. 5 is a top level diagram of Virtual Fitting Room System deployment environment and main data flows;

FIG. 6 is a diagram of Virtual Fitting Room System major components and interactions.

### DETAILED DESCRIPTION OF THE PREFERRED EMBODIMENT

Device and method to measure and record 3D dimensions of human body are described below.

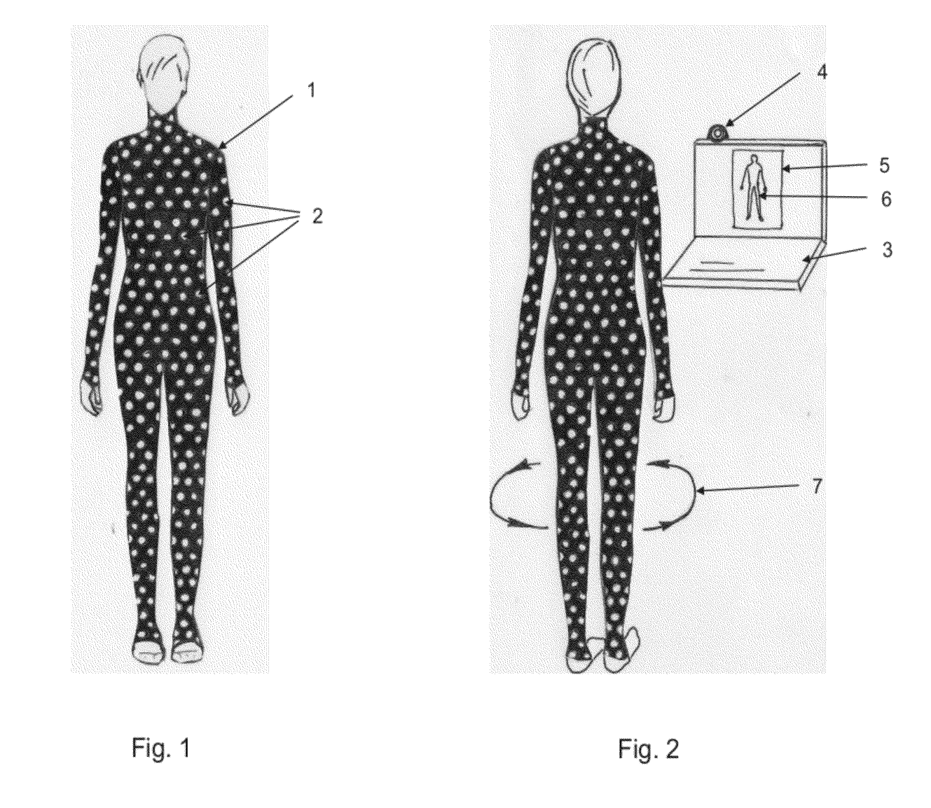

The device includes a full body costume 1 (an envelope pulled over the body) shown in FIG. 1. In one embodiment, it is made of stretchable fabric. Customer orders the costume through one of the affiliated on-line retailers. The costume is mailed to the customer. The costume comes in several sizes. The size of the costume for the customer is selected during ordering to fit tightly using a standard size grid.

The costume material has clearly visible markers 2. Preferably, the color of the costume material is black, and the color of the markers is white to increase the contrast and reduce lighting requirements. The markers are printed on the costume material and, in one embodiment, have a shape of a circle. The spacing of the markers in this example is 25 mm and the diameter of the markers is 8 mm. If higher resolution is needed the size of the markers may be smaller and their spacing closer.

After the costume is fitted on a customer, the customer positions her body in front of the computer 3 with a camera 4 as shown in the FIG. 2.

VFR 3D Body Shape Client Software 25 displays on the computer screen: a video image of the customer 6 as customer positions herself in the camera view; a rectangular 5 in the center of the camera view to help the customer assure an optimum position for the measurements and thus improve the recording performance.

Customer starts filming by the voice command and slowly turns around 7, maintaining body posture. When turn is completed, the customer bents forward to expose markers on the shoulders, makes a partial turn with her hands elevated to expose markers under armpits.

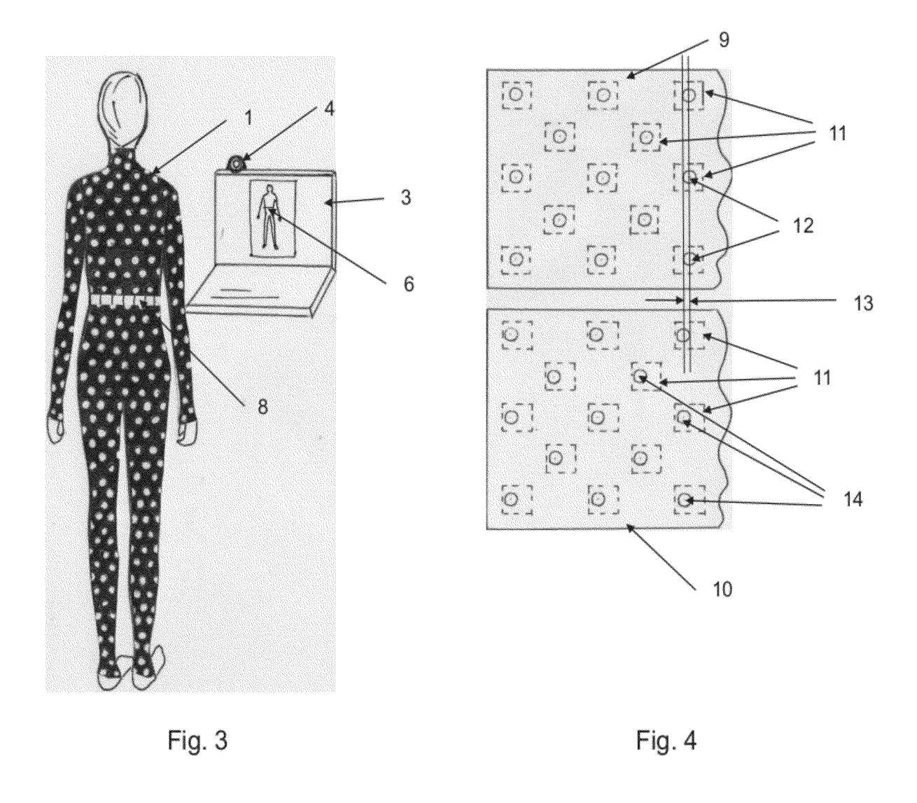

To calculate physical dimensions of the body photogarmmetry software needs to scale relative distances between the markers using at least two references with known distance between them or it can use reference body measurement. To provide this reference measurement the client applies tape measure 8 to the waistline as shown in FIG. 3 and inputs the length of the waistline in the program. Alternatively, a scale can be place in the view of camera thus providing a reference base to facilitate the scaling. Other methods of scaling may apply.

At this point all the necessary data has been acquired and camera is stopped, preferably, with by a voice command of the customer.

Resulted film and reference measurement are send to the VFR server over the internet and processed there frame by frame. In the first frame all the visible markers are found, sequentially numbered, their X,Y coordinates are measured (X,Y pixel numbers of the marker's center). In the next frame markers located within the predefined distance from the markers in the first frame are assigned the same numbers and so on.

One can visualize this process looking at FIG. 4. In this figure every marker 12 in the segment of the film's first frame 9 is surrounded by a virtual box 11 centered on the marker. The size of the box is selected to be bigger than possible change of the marker position between sequential frames, but smaller than the distance between centers of the adjacent markers. The position of the same marker 14 in the next sequential frame 10 (second frame of the film) is shown shifted by small distance 13 but within the same virtual box 11 defined in the first frame.

For example, assuming the circumference of the body to be 6 feet (72″), duration of the full body turn captured by the camera to be 20 seconds and camera frame rate of 30, the average movement of the marker between two sequential frames is L=(72:20):30=0.12 inch or about 3 mm. If the turn time is 30 seconds and the frame rate is 60, the average marker movement between frames is about 1 mm, allowing close spacing of the markers and margin for tracking.

New markers appearing on subsequent frames as a result of customer turning around and moving in front of the camera are assigned next sequential numbers and tracked as described above. Thus automatic registration of homologous markers (markers mutually corresponding to each other in the different frames) is achieved and photogrammetric determination of the 3D coordinates of the body is carried out.

To scale calculated 3D shape image the recognition software determines circumference of the body where the tape measure was applied, calculates the length of circumference, compares it to the tape measure input. The ratio of the calculated length and actual tape measurement is used to scale 3D shape to actual physical dimensions.

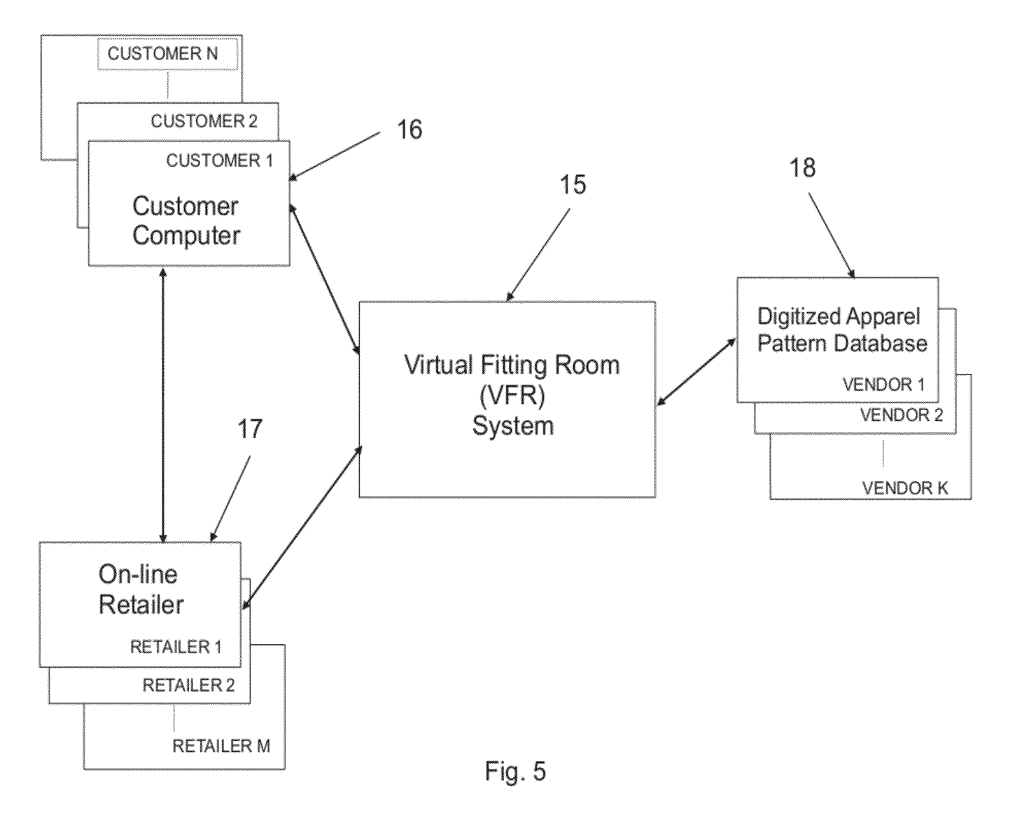

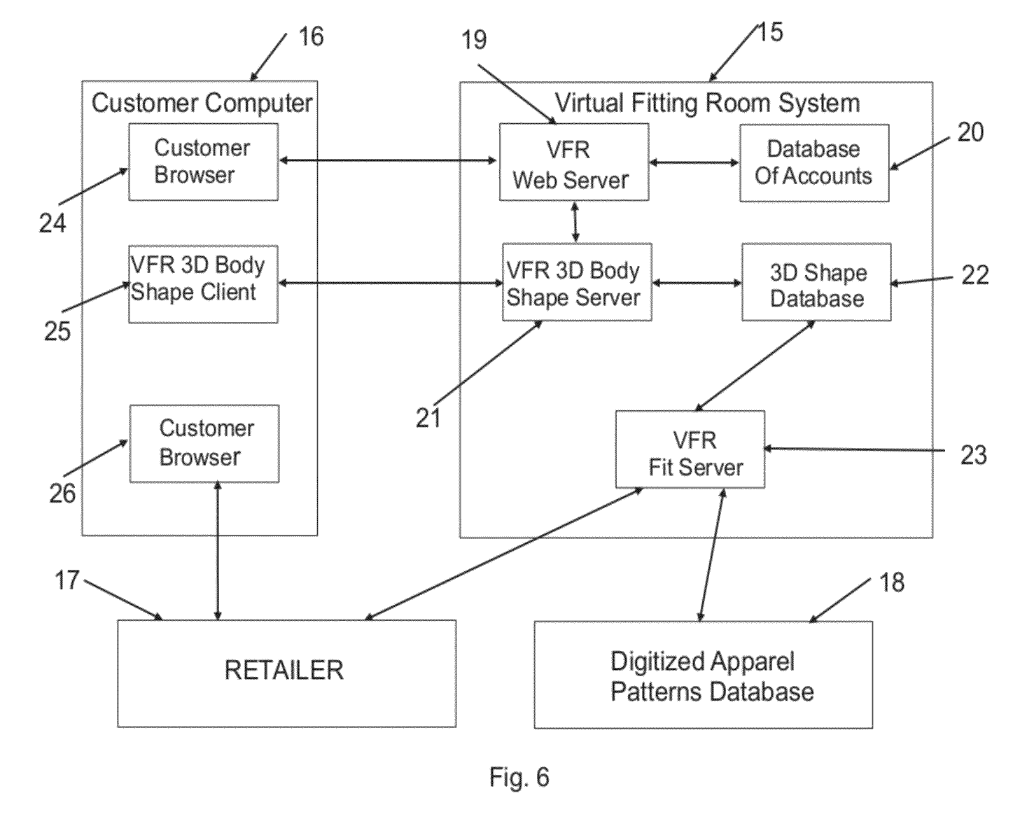

One embodiment of the Virtual Fitting Room System 15 described here is shown in FIG. 5. FIG. 5 shows main elements and information flows of the preferred deployment environment of the System 15, including customer computer 16, on-line retailer server 17 and apparel vendor Digitized Apparel Patterns Database 18. Information flows are shown by connecting arrows. After receiving enveloping body suit with markers imprinted in the mail, the customer creates an account on the website 24. FIG. 6 of the VFR webserver 19 and logs in this account. She puts on the costume and starts filming her body using 3D Body Shape Client software 25 as described above. The completed film is transferred via internet connection from the customer computer 16 to the VFR 3D Body Shape Server 21. VFR 3D Body Shape Server 21 processes the film, calculates 3D dimensions of the customer body and stores this data in the 3D Shape Database 22. In one embodiment, the customer email is assigned to be customer ID for the future 3D body shape retrieval requests.

In the preferred embodiment the client goes to the retailer website 17 using a browser 26, selects clothing item and requests fitting service. The client's request is sent by the retailer 17, together with the customer ID and selected item ID to the VFR Fit Server 23 via internet connection.

The VFR Fit Server 17 sends request for the digitized representation of the clothing item selected by the customer to the Digitized Apparel Pattern Database 18, using clothing item ID, via internet connection.

The Digitized Apparel Pattern Database 18 sends digitized representation of the requested clothing item via internet connection to the VFR Fit Server 17.

The VFR Fit Server retrieves customer body shape from 3D Shape database 22 using customer ID provided by the retailer, runs virtual fitting software using customer 3D shape and digitized representation of the garment, generates virtual pictures of the selected clothing item on the customer body, and sends these pictures back to the retailer via the internet link 19.

The retailer displays pictures of the selected apparel item fitted over digitized 3D shape of the customer body.

While embodiment of the present invention has been described above, it should be understood that it has been presented by way of example only, and not limitation. Thus, the breadth and scope of the present invention should not be limited by the above-described exemplary embodiment, but should be defined only in accordance with the following claims and their equivalents.

The previous description of the preferred embodiment is provided to enable any person skilled in the art to make or use the present invention. While the invention has been particularly shown and described with reference to preferred embodiment thereof, it will be understood by those skilled in the art that various changes in form and details may be made therein without departing from the spirit and scope of the invention.

1. A method of digitized 3D sensing of the shape of an object, including the steps of:
acquiring a motion picture of the rotating and moving object using digital camera;
the object having visible markers;
extracting 2D frame coordinates of the markers;
performing automatic registration of the markers in different frames by tracking the markers from one frame to another, based on a proximity of the same markers in the sequential frames;
performing a processing of markers coordinates to determine 3D dimensions of the object using a photogrammetric method;
performing scaling of 3D dimensions of the object.

2. The method of claim 1, wherein the object is a human body and the method is self administered.

3. The method of claim 2, wherein the markers have a size of 2 mm to 10 mm.

4. The method of claim 2, wherein the markers centers are spaced from 6 mm to 35 mm from each other, and the marker's size is less than the distance between the marker centers.

5. The method of claim 2, wherein the scaling comprises
performing said scaling using at least two markers with known distance between them, placed on a scale filmed with the human body being measured.

6. The method of claim 2, wherein the scaling is based on at least one direct measurement of the body.

7. The method of claim 2, further comprising:
storing said 3D body shape measurements in a database, which is further used for virtual fitting of apparel of various providers.

8. The method of claim 2, wherein the motion picture is taken by a computer controlled camera operated by a person whose body measurements are being taken, the person not skilled in measurements, photography and filming.

9. The method of claim 2, further comprising:
controlling the motion picture recording using a computer software; the software running an interface, which helps the person whose body measurements are being taken, to improve the imaging performance.

10. The method of claim 2, wherein the motion picture recording and the 3D image processing and storage are performed at distant locations connected via Internet.

11. The method of claim 2, further comprising:
elastic, enveloping body suit with the markers placed on the suit; the body suit being dressed on the person whose shape is measured, wherein the markers have color contrasting to the color of the body suit, wherein the markers shape, markers pattern or pattern of the markers spacing do not affect the performance of the method.

12. The method of claim 2 wherein the film is acquired by of the shelf low end camera, in a lighting conditions prevailing in regular house or an apartment.

13. The method of claim 2, wherein the markers are spaced in such a way that a distance between neighboring markers is at least two times greater than the distance that any marker moves between sequential frames during film recording.

14. A system for providing internet based virtual fitting room service for online apparel retailers and their customers, comprising:
a Virtual Fitting Room (VFR) server to obtain, measure, store and renew the customer's three dimensional (3D) body shape image;
a Virtual Fitting Room software being capable of electronically retrieving digitized patterns used for construction of a given apparel from a retailer or from an item manufacturer;
the software combining the customer's 3D body image and the apparel to virtually dress the customer and to visualize the dressed image to see how the apparel item fits.

15. The system of claim 14, wherein a data required for the customer body measurement is acquired at a customer's location, using customer's computer and then transferred to a VFR system for processing and storage.

16. The system of claim 14, wherein the data required for the customer body measurement is created by acquiring a motion picture of a rotating and moving human body having visible markers.

17. The system of claim 14, wherein a VFR database comprises digitized 3D body shapes of multiple customers.

18. The system of claim 14, wherein a VFR has an interface allowing accessing digitized apparel patterns of multiple manufacturers.

19. The system of claim 14, wherein a VFR has an interface allowing receiving of requests from multiple retailers to fit the customer identified by a customer identification information (ID) in an apparel item identified by unique item ID.

20. A method of virtually trying an apparel over a customer body, comprising:
recording a customer image movie at his computer camera performed by the customer, sending this customer image movie to a virtual fitting room (VFR) for a processing;
obtaining a customer's 3D body shape;
selecting an apparel for trying to fit from an internet selling point;
requesting the VFR to fit that apparel on the customer body; and
viewing an image of the customer's body dressed in the selected apparel.
